(19) United States
(12) Patent Application Publication
(10) Pub. No.: US 2011/0066710 A1
(43) Pub. Date: Mar. 17, 2011

(54) Approach for Publishing Content to Online Networks

(75) Inventor: Amita Paul, Redwood City, CA (US)

(73) Assignee: ObjectiveMarketer, Redwood City, CA (US)

(21) Appl. No.: 12/611,864

(22) Filed: Nov. 3, 2009

Related U.S. Application Data
(60) Provisional application No. 61/242,342, filed on Sep. 14, 2009.

(51) Int. Cl. G06F 15/177

(52) U.S. Cl. 709/222

(57) ABSTRACT

A computer-implemented system and method are provided for publishing content to online networks. According to one embodiment of the invention, a unique identifier and text are received from a user, and a text-based character string is generated from the received text. The text-based character string is then associated with one classification, and the text-based character string is transmitted to at least one online social networking account configured to receive content from said user.

### RELATED APPLICATIONS

This application claims priority based on U.S. Provisional Patent Application No. 61/242,342, filed on Sep. 14, 2009 entitled “System and Method for Publishing Content to Online Networks.”

### BACKGROUND

The invention relates to the field of online social networking, and, more particularly, to an approach for customizing the manner in which links to external content are presented to users of social networks and categorizing said links for the purpose of measuring viewer response.

Online social networks have become a ubiquitous tool of communication for individuals and organizations. Such networks allow users to create a profile on which the user may post content using a client computer program configured to access the network (e.g., a web application) or a through a communications channel designated by the network as a point of receipt for new content (e.g., SMS). These services typically employ a model whereby a user can maintain a list of contacts consisting of other users of the network whose profile the user may view and whose activity—posting of new messages, pictures, videos, and other content—the user may be kept apprised of in real-time.

Among the most popular features of such networks is the ability to post status messages and links to content on external sites. A status message is a text-based message of a limited number of characters that the user may post to his/her profile. Subject to the user's account privacy settings, the message may, upon transmission, be immediately visible to all or a subset of the network's user base. Typically, a user may receive real-time updates of new status messages from all of the users on his/her contact list Links to content on external sites may be embedded within a status message or, in some networks, posted as a distinct type of content.

When a user wishes to post a link to content on an external site, it is often desirable to substitute the URL of an intermediary site that redirects to the target page, or displays the target page from within a page on the intermediary site, rather than posting the URL of the target page itself. This technique offers a number of advantages.

If the link is embedded within a status message, the low character limits of status messages (typically 140 characters per message) coupled with the large number of characters that often comprise the URL of a web page invite the use of a URL shortener. A URL shortener is a service that employs a very short domain name and a technique that encodes the target page's URL as a character string of minimal length. This results in an alias URL for the target page that limits the number of characters needed for the link and maximizes the number of characters available to the user for accompanying text. Popular URL shorteners include bit.ly, tr.im, and tinyurl.

In addition, the use of an intermediary site allows the user to present the target page within a landing page. A landing page is a web page users arrive at after clicking a link. As used in the field of URL shortening, a landing page is understood by those skilled in the art to comprise a banner including graphics, logos, text or options added by the shortening service displayed as a frame along the top, bottom, or side of a web page. The target page is displayed as a frame adjacent to the landing page. HootSuite is one such utility that shortens URLs and presents target pages within a landing page.

The use of an intermediary site also allows the user to track how many times the link has been selected (the “click count”) and provides the target site with a reliable indicator of the referring party's identity. An intermediary site facilitates the former objective by recording all instances that the link is selected. The role of an intermediary site in the latter objective is subtle yet significant: although the target site receives the URL of the referring page in any case, the URL of a social network profile page from which a viewer follows a link to external content may not be consistent or meaningful.

Online social networks are continually modifying their primary user interfaces and increasingly allowing access to user profile content through third-party applications. The use of an intermediary site accounts for this effect by providing a meaningful referrer URL that is independent of the platform from which the user profile is accessed. Because the economics of Internet advertising and revenue sharing revolve largely around referrals and click counts, this advantage is particularly important in commercial contexts where the referring party is compensated based on traffic flowing to the target site from the referring site.

Due to the exponential growth in Internet access and the emergence of sophisticated tools that extend the availability of online services beyond the computer, online social networking is taking its place alongside television, print advertising, and more traditional forms of media as an indispensable means of communication for businesses and media outlets. Businesses have begun using online social networks as marketing platforms, enabling them to reach vast numbers of potential customers at minimal cost. These businesses may create profile pages within such networks to disseminate news, information about specials and promotions, and new product announcements to customers. Media outlets may rely on such networks as a means of informing their readers of new content or site updates away from their normal visits to the outlet's standard content portal. The rise of online social networking has thus changed the traditional concept of a destination page; whereas in the past, traffic to most content would flow exclusively from search engines or homepages, many Internet users now arrive at content by following links from pages on social networking sites, thereby turning online social networks into de facto content portals.

However, there currently exists no system or method for customizing the manner in which external content linked from social network profiles is presented to the viewer or categorizing such links by message author or user-defined classifications for the purpose of generating detailed viewer response analytics. The URL shorteners currently in use do not allow users to customize the appearance and content of a landing page, nor do they provide a means for collecting and analyzing data on click counts according to user-defined categories or author. Such functionality would be particularly useful to entities using online social networks for marketing or other commercial purposes.

The ability to customize a landing page with the user's own logos, images, and text would be useful to users who wish to maintain a presence within a viewer's browsing experience even after the viewer has followed a link to external content. For instance, a commercial user may seek to create an association between its brand and certain types of content as part of its brand communication strategy. A customizable landing page enables the user to direct viewers to such content while keeping the user's logo, slogan, and other information displayed noticeably but unobtrusively within the viewer's browser window.

Similarly, the value of detailed viewer click count metrics is akin to that of data provided by organizations such as The Nielsen Company, which researches viewer response and consumption patterns in a variety of media. The fully interactive nature of online communication allows for more accurate data in measuring viewer response to content delivered via online social networks than similar research involving non-interactive media such as television or print publications, which is typically conducted through surveys and focus groups. The ability to classify links according to author or other user-defined criteria allows users to group links together and compare viewer response rates to determine which authors and classifications are generating the most interest.

For these reasons, a system that allows for such customization and data gathering would be particularly valuable. As will be seen, the invention provides such a system in an elegant manner.

### BRIEF DESCRIPTION OF THE DRAWINGS

FIG. 1 is a diagram depicting an approach for posting content to online networks according to an embodiment.

FIG. 2 is a flow diagram depicting an approach for posting content to online networks according to an embodiment.

FIG. 3 is a flow diagram depicting an approach for posting content to online networks according to an embodiment.

FIG. 4a is a screenshot of an example user interface according to an embodiment.

FIG. 4b is a screenshot of a posted message within the user interface of an example online network according to an embodiment.

FIG. 4c is a screenshot of a webpage pointed to by an alias URL in an example message according to an embodiment.

FIG. 5 is a block diagram of a computer system upon which embodiments of the invention may be implemented.

### DETAILED DESCRIPTION

The embodiments discussed herein generally relate to an apparatus, system and method for publishing content to online social networks. The online social networks may include any network currently in use that allows third-party applications to post content to user profiles, or any network that may provide such functionality in the future. Referring to the figures, exemplary embodiments will be described. The exemplary embodiments of the invention are provided to illustrate the embodiments and should not be construed as limiting the scope of the embodiments.

In the following disclosure, numerous specific details are set forth to provide a thorough understanding of the invention. However, those skilled in the art will appreciate that the invention may be practiced without such specific details. In other instances, well-known elements have been illustrated in schematic or block diagram form in order not to obscure the invention in unnecessary detail. Additionally, for the most part, details concerning network communications, data structures, and the like have been omitted inasmuch as such details are not considered necessary to obtain a complete understanding of the invention, and are considered to be within the understanding of persons of ordinary skill in the relevant art. It is further noted that all functions described herein may be performed in either hardware or software, or a combination thereof, unless indicated otherwise. Certain terms are used throughout the following description and claims to refer to particular system components. As one skilled in the art will appreciate, components may be referred to by different names. This document does not intend to distinguish between components that differ in name, but not function. In the following discussion and in the claims, the terms “including”, “comprising”, and “incorporating” are used in an open-ended fashion, and thus should be interpreted to mean “including, but not limited to . . . ”. Also, the term “couple” or “couples” is intended to mean either an indirect or direct electrical or communicative connection. Thus, if a first device couples to a second device, that connection may be through a direct connection, or through an indirect connection via other devices and connections.

The invention offers a number of advantages over the prior art. There are numerous third-party utilities that allow users to post content to online networks. Most URL shorteners currently in use, such as the aforementioned bit.ly, tr.im, and tinyurl, do not display a landing page of any kind alongside the target page. Some of these services, such as bit.ly, do provide viewer click count data. However, this functionality is limited; none of these services allow users to group links by user-defined categories or allow multiple uniquely identified users to post content from within the same account. One URL shortening service, HootSuite, does provide a landing page. However, HootSuite's landing page is non-customizable and static; there are no options for the user to create landing pages or associate a landing page with a specific link.

The invention is distinguished from the prior art by providing the ability to assign user-defined classifications and keywords to messages posted to online social networks and allowing for multiple uniquely identified users to post content from within the same account. This enables the user to receive click count data for links arranged by message author and user-defined classifications. Additionally, the invention allows the user to create custom landing pages and associate a message or all messages within a classification with a specific landing page. This enables the user to customize the manner in which content pointed to by a link is presented to a viewer.

The invention is directed to a computer-implemented method for providing links to Internet content. More particularly, the method comprises receiving a unique identifier from a user, generating a text-based character string, associating the text-based character string with one classification, and transmitting the text-based character string to at least one online social networking account configured to receive content from the user.

In one embodiment, the method may further comprise receiving from the user a primary URL pointing to content stored on a network server. In this embodiment, an alias URL may be generated from the primary URL wherein the content pointed to by the primary URL may also be accessed through the alias URL. The alias URL may comprise a text-based character string identifying a protocol, a text-based character string identifying a domain, and a text-based character string identifying a file path and corresponding to the primary URL. The text-based character string identifying the file path may be generated from the primary URL by at least one algorithm. The alias URL may point to a webpage incorporating the content pointed to by the primary URL. In this embodiment, the text-based character generated by the method may comprise the alias URL and any additional text received from the user.

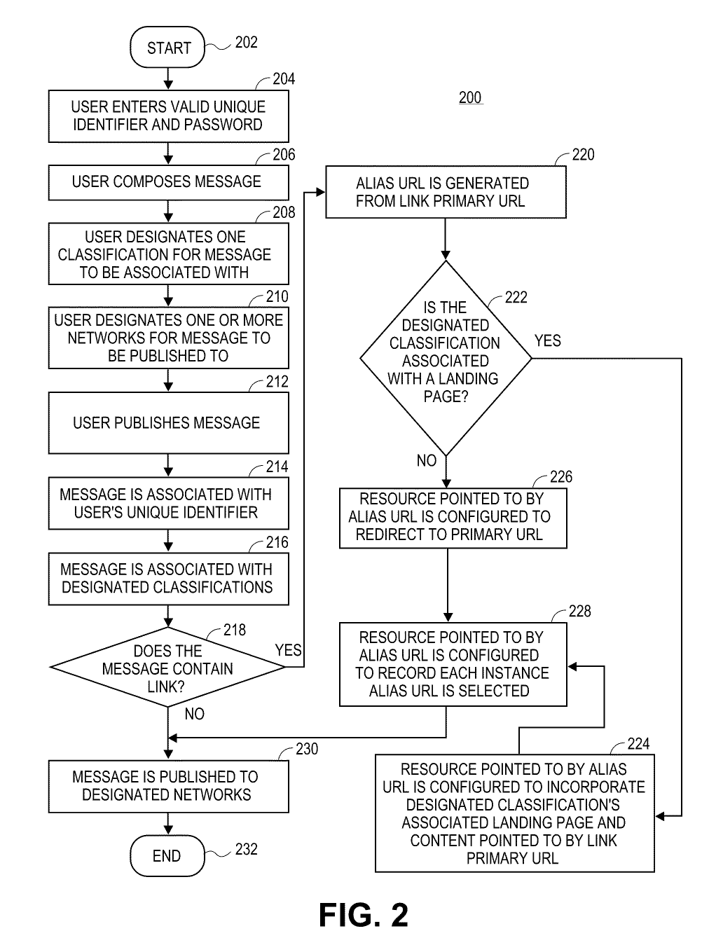

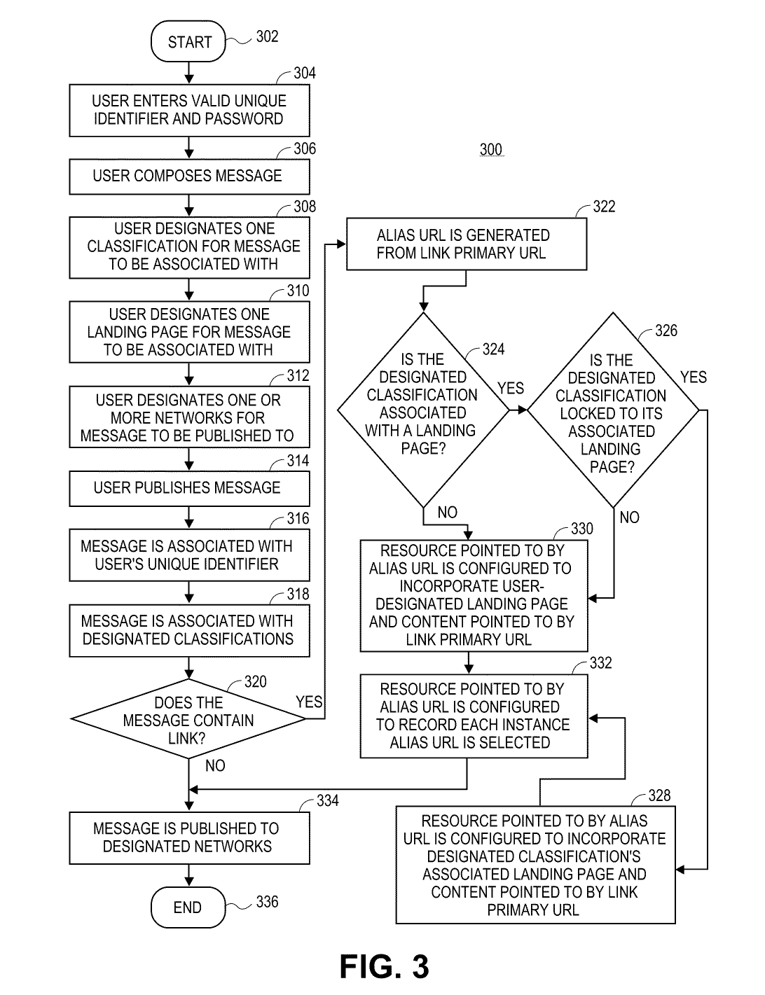

In another series of embodiments, the text-based character string may be associated with a landing page. This may be accomplished directly by associating an individual text-based character string with an individual landing page, or indirectly, in a separate procedure, by associating a classification with a landing page as described below in reference to FIGS. 2 and 3. The text-based character string may thus be automatically associated with the classification's associated landing page. In these embodiments, the landing page may comprise at least one of a link to a binary graphic and a text-based character string of at least one character. The landing page may be received from said user and stored. The alias URL may point to a resource comprising the content pointed to by the primary URL and the text-based character string's associated landing page.

In any of the embodiments described herein, the classification may comprise a text-based character string and may be received from the user and stored. A classification may be associated with at least one keyword, which itself may comprise a text-based character string and may be received from the user and stored.

In any of the embodiments described herein, the text-based character string may be associated with the unique identifier corresponding to the user. The unique identifier may be associated with an organization, and the organization may in turn be associated with an agency.

Another embodiment of the invention comprises a computer system for transmitting content to online networks which may include a computer coupled to a digital communications network by a digital telecommunications link, an electronic digital memory in the computer, and one or more sequences of computer program instructions stored in the electronic digital memory. When executed, the sequences of computer program instructions cause the computer to perform the steps included in any of the embodiments described herein.

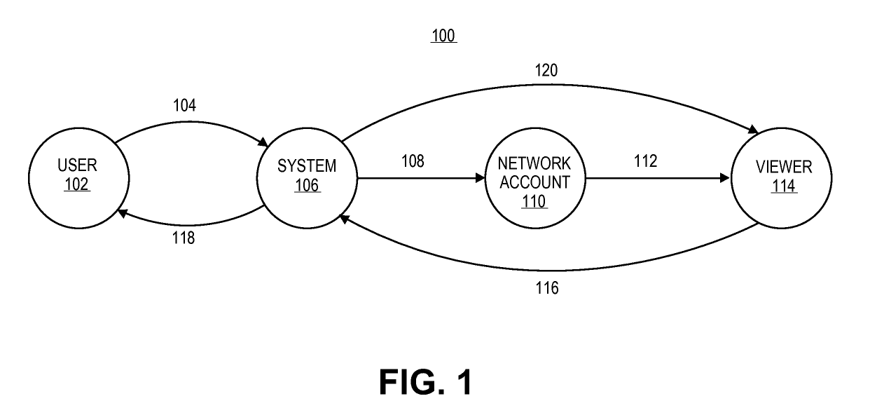

A few example embodiments are illustrated in the drawings. Referring to FIG. 1, a block diagram 100 illustrates an approach for posting content to online networks according to various embodiments described herein. A user 102 provides data including a text-based character string containing a URL, a classification with which said text-based character string is to be associated, and optionally, a landing page with which said text-based character string is to be associated to the system 106 over a connection 104. Upon receiving the data from the user 102, the system 106 associates said text-based character string with the user 102 as well as with a classification and landing page as specified by the user 102. The system 106 then generates an alias URL from the user-provided URL, substitutes the alias URL for the user-provided URL within the text-based character string, and transmits said text-based character string over a connection 108 to an online social network account 110. When accepted by the network account 110, said text-based character string becomes accessible to a viewer 114 who may view content associated with the network account 110 over a connection 112. Upon selecting the URL contained within said text-based character string, data including the referring URL, the current date and time, and the IP address of the user are transmitted to the system 106 via a connection 116 where they are recorded. The user may at any time receive reports based on this recorded data via a connection 118. The viewer 114 receives the content pointed to by the alias URL, which includes the content pointed to by the user-provided URL and the user-provided landing page, via a connection 120. Connections 104, 108, 112, 116, 118, and 120 may be formed over any medium for transferring data.

Referring to FIG. 2, a flow diagram 200 illustrates an approach for composing text-based messages and publishing them to online social networks. According to one embodiment, a user begins at step 202 by entering a valid unique identifier and password at step 204. At step 206, the user composes a text-based message that may or may not contain a link identified by a primary URL. At step 208, the user designates a classification to associate the message with. At step 210, the user designates one or more networks to publish the message to. When the user publishes the message at step 212, the message is associated at step 214 with the user by his/her unique identifier as entered at step 202. The message is then associated at step 216 with the classification designated by the user at step 208. At step 218, a determination is made whether the message contains a link identified by a primary URL. If the message does contain a link, an alias URL is generated at step 220 from the primary URL of the link, the alias URL is substituted for the primary URL within the message, and the process proceeds to step 222. If the message does not contain a link, the message is published at step 230 to the networks earlier designated by the user at step 208 and the process is complete at step 232.

Following step 220, a determination is made at step 222 whether the classification designated by the user at step 210 is associated with a landing page. If the classification is associated with a landing page, the resource pointed to by the alias URL is configured at step 224 to incorporate the designated classification's associated landing page and the content pointed to by the link primary URL. If the classification is not associated with a landing page, the resource pointed to by the alias URL is configured at step 226 to redirect to the primary URL. In either case, the resource pointed to by the alias URL is then configured at step 228 to record each instance that the alias URL is selected. The message is published at step 230 to the networks earlier designated by the user at step 208 and the process is complete at step 230.

Another embodiment is illustrated in the flow diagram 300 of FIG. 3. This embodiment relates to cases in which the user designates a landing page in addition to designating a classification. In such cases, a user may, in a preferences section within the user interface, specify whether a classification is “unlocked” or “locked” to its associated landing page, i.e., whether the user may override the classification's associated landing page and specify a different landing page while authoring a message. If the classification is locked to its associated landing page, the system ignores any designations by the user specifying a landing page or prevents the user from specifying a landing page when such a classification is selected during message composition. If the classification is not locked to its associated landing page, the user may optionally designate a landing page when designating such a classification during message composition, and the system will associate the message with the user-designated landing page instead of the classification's associated landing page.

In this embodiment, the user begins at step 302 by entering a valid unique identifier and password at step 304 and composing a message at step 306 that may or may not contain a link identified by a primary URL. After designating at step 308 a classification for the message to be associated with, the user designates at step 310 a landing page for the message to be associated with. At step 312, the user designates one or more networks to publish the message to. When the user publishes the message at step 314, the message is associated at step 316 with the user by his/her unique identifier as entered at step 302. The message is then associated at step 318 with the classification designated by the user at step 308. At step 320, a determination is made whether the message contains a link identified by a primary URL. If the message does contain a link, an alias URL is generated at step 322 from the primary URL of the link, the alias URL is substituted for the primary URL within the message, and the process proceeds to step 324. If the message does not contain a link, the message is published at step 334 to the networks designated by the user at step 308 and the process is complete at step 336.

A determination is made at step 324 whether the classification designated by the user at step 308 is associated with a landing page. If the classification is associated with a landing page, then a determination is made at step 326 whether the classification designated by the user at step 308 is locked to its associated landing page. If the classification is locked to its associated landing page, then the user's designation of a landing page at step 310 is ignored and the resource pointed to by the alias URL is configured at step 328 to incorporate the designated classification's associated landing page and the content pointed to by the link primary URL. The process then proceeds to step 332. If the classification is not locked to its associated landing page, the classification's associated landing page is ignored and the process proceeds to step 330. If at step 324 the classification is not associated with a landing page, the process proceeds to step 330.

At step 330, the resource pointed to by the alias URL is configured to incorporate the landing page designated by the user at step 310 and the content pointed to by the link primary URL. At step 332, the resource pointed to by the alias URL is configured to record each instance that the alias URL is selected. The message is then published at step 334 to the networks earlier designated by the user in step 308 and the process is complete at step 336.

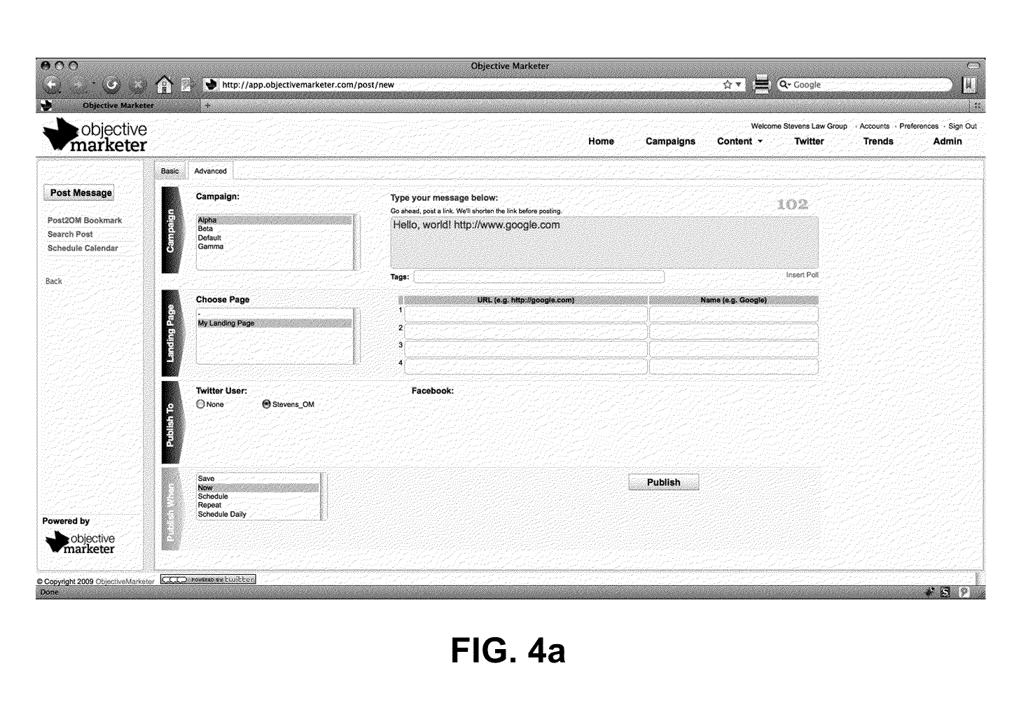

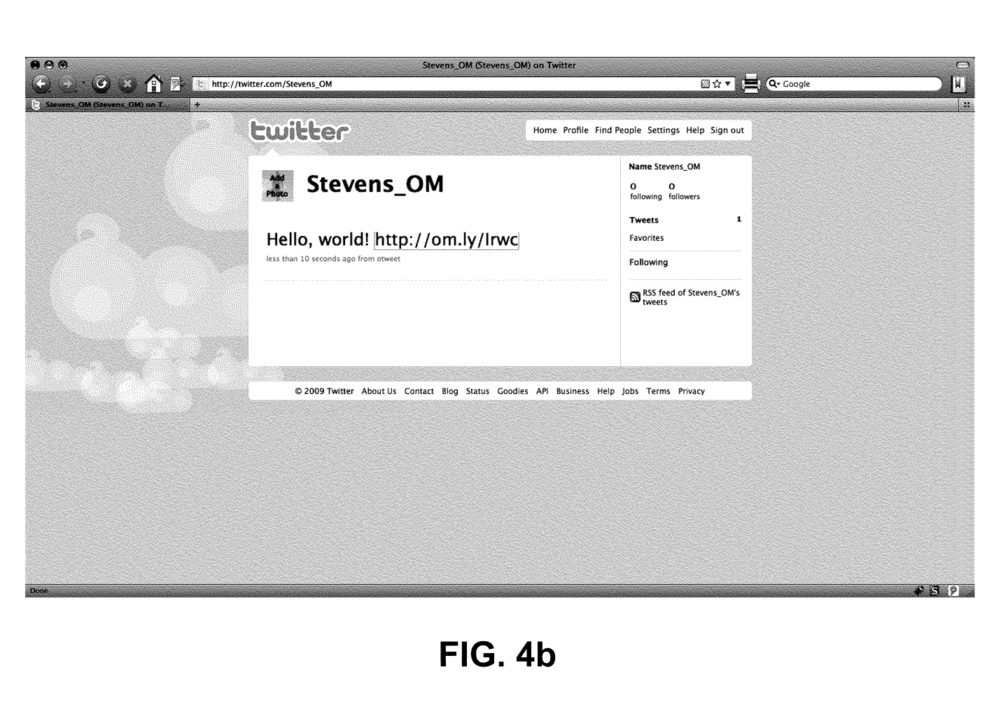

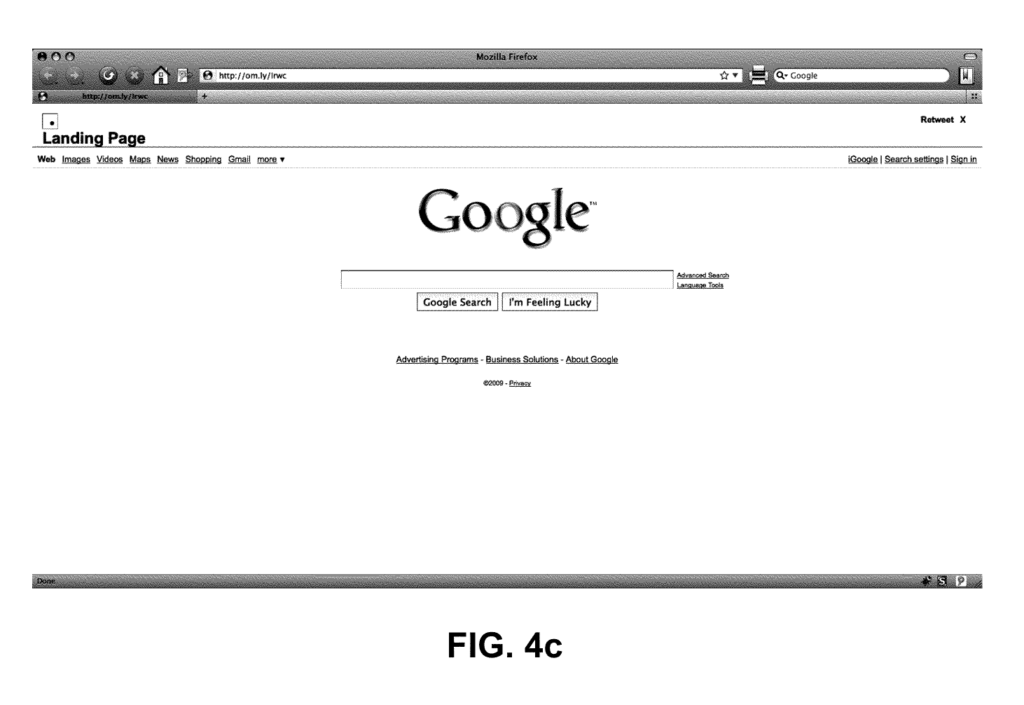

FIGS. 4a, 4b, and 4c illustrate screenshots of example user interfaces and resources pointed to by alias URLs according to various embodiments described herein. These figures collectively illustrate an example instance of the claimed system and method in operation according to an embodiment. FIG. 4a illustrates an example user interface wherein the user has composed a message consisting of the text “Hello, world! http://www.google.com”. The user has associated the message with classification ‘Alpha’ (which, in this embodiment, is referred to as a campaign) and with landing page ‘My Landing Page’. The user has designated account ‘Stevens_OM’ within network ‘Twitter’ for the message to be transmitted to. FIG. 4b illustrates a user interface of online network ‘Twitter’ displaying content from user account ‘Stevens_OM’. The transmitted message from FIG. 4a is displayed wherein the alias URL ‘http://om.ly/lrwc’ has been substituted for the user-provided URL ‘http://www.google.com’. FIG. 4c illustrates the resource displayed when the alias URL ‘http://om.ly/lrwc’ is selected by a viewer from a user interface of account ‘Stevens_OM’ within network ‘Twitter’. The resource comprises the landing page designated by the user in FIG. 4a and the resource pointed to by the user-provided URL ‘http://www.google.com’ displayed adjacent to each other.

In any of the embodiments described herein, access to the system is provided through an account, an allocation of resources within the system designated for a specific entity and associated with one or more set of unique credentials. A single account within the system may be configured to provide multiple uniquely identified users with varying levels of access and administrative privileges. In one embodiment, all of the users within an account (the “agency”) are categorized into sub-groups (“organizations”). In this embodiment, users with an appropriate level of administrative privileges may access data relating to all users within an organization or agency. In a procedure separate from composition and transmission of messages, a user may create and store within the system classifications, keywords associated with each classification, and landing pages for use during message composition. When implemented in conjunction with the message classification steps described herein, this approach enables a user to receive click count metrics sorted and presented according to message author, agency, organization, keyword, and user-defined classification.

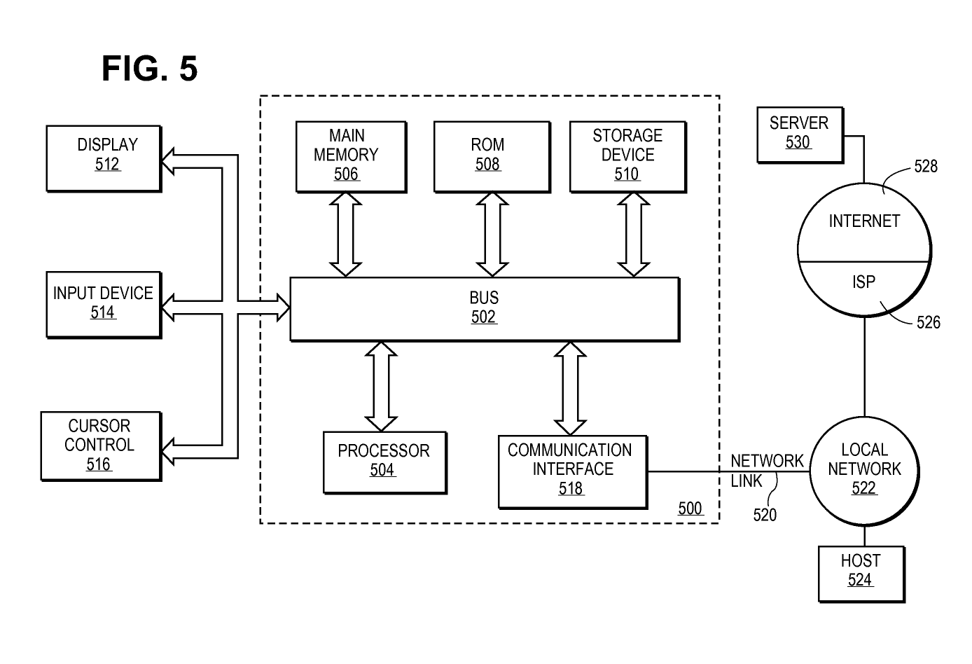

Referring to FIG. 5, a diagrammatic view of a computer system 500 configured according to the invention is illustrated. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for transmitting content to online networks. According to one embodiment of the invention, the transmission of content to online networks is provided by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the Internet 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In any of the embodiments described herein, a server 530 might transmit data through Internet 528, ISP 526, local network 522 and communication interface 518.

The received instructions may be executed by processor 504 as they are received, and/or stored in storage device 510, or other non-volatile storage for later execution. In this manner, computer system 500 may obtain data in the form of a carrier wave. The processor 504 may be a specialized or dedicated microprocessor that is configured to perform particular tasks according to the invention, by executing machine-readable software code that defines the particular tasks embodied by the invention.

The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. As described above in reference to FIG. 5, main memory 506 is included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the invention. The machine-readable medium includes any mechanism that provides (i.e., stores and/or transmits) information in a form readable by a machine (e.g., a computer, PDA, cellular telephone, etc.). For example, a machine-readable medium includes memory (such as described above); magnetic disk storage media; optical storage media; flash memory devices; biological electrical, mechanical systems; electrical, optical, acoustical or other form of propagated signals (e.g., carrier waves, infrared signals, digital signals, etc.). The device or machine-readable medium may include a micro-electromechanical system (MEMS), nanotechnology devices, organic, holographic, solid-state memory device and/or a rotating magnetic or optical disk. The device or machine-readable medium may be distributed when partitions of instructions have been separated into different machines, such as across an interconnection of computers or as different virtual machines.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The apparatus and method include a method and apparatus for enabling the invention. Although this embodiment is described and illustrated in the context of devices, systems and related methods of managing and social networks, the scope of the invention extends to other applications where such functions are useful. Furthermore, while the foregoing description has been with reference to particular embodiments of the invention, it will be appreciated that these are only illustrative of the invention and that changes may be made to those embodiments without departing from the principles, the spirit and scope of the invention, the scope of which is defined by the appended claims, their equivalents, and also later submitted claims and their equivalents.

What is claimed is:

1. A computer-implemented method for providing links to Internet content, the method comprising:
receiving a unique identifier from a user;
receiving text from said user;
generating a text-based character string from the received text;
associating said text-based character string with one classification;
transmitting said text-based character string to at least one online social networking account configured to receive content from said user.

2. The method of claim 1, further comprising receiving a primary URL pointing to content stored on a network server from said user;

3. The method of claim 2, further comprising generating an alias URL from said primary URL wherein the content pointed to by primary URL may also be accessed through alias URL;

4. The method of claim 3, wherein said text-based character string comprises said alias URL;

5. The method of claim 3, wherein said alias URL comprises a text-based character string identifying a protocol, a text-based character string identifying a domain, and a text-based character string identifying a file path and corresponding to said primary URL.

6. The method of claim 5, wherein said text-based character string identifying a file path is generated from said primary URL by at least one algorithm.

7. The method of claim 3, wherein said alias URL points to a webpage.

8. The method of claim 7, wherein said webpage incorporates said content pointed to by said primary URL.

9. The method of claim 3, wherein said text-based character string further comprises additional text accompanying said alias URL.

10. The method of claim 4, further comprising associating said text-based character string with a landing page.

11. The method of claim 10, wherein associating said text-based character string with a landing page is performed by associating said text-based character string's associated classification with a landing page.

12. The method of claim 10, wherein said landing page comprises at least one of a link to a binary graphic and a text-based character string of at least one character.

13. The method of claim 10, wherein said landing page is received from said user and stored.

14. The method of claim 10, wherein said alias URL points to content comprising the content pointed to by primary URL and said associated landing page.

15. The method of claim 1, wherein said classification comprises a text-based character string.

16. The method of claim 15, wherein said classification is received from said user and stored.

17. The method of claim 1, further comprising associating said classification with at least one keyword.

18. The method of claim 17, wherein said at least one keyword comprises a text-based character string.

19. The method of claim 18, wherein said at least one keyword is received from said user and stored.

20. The method of claim 1, further comprising associating said text-based character string with said unique identifier.

21. The method of claim 1, wherein said unique identifier is associated with an organization.

22. The method of claim 21, wherein said organization is associated with an agency.

23. A computer system for transmitting content to online networks comprising:
a computer that is coupled to a digital communications network by a digital telecommunications link;
an electronic digital memory in the computer;
one or more sequences of computer program instructions stored in the electronic digital memory which, when executed, cause the computer to perform the steps of:
receiving a unique identifier from a user;
receiving text from said user;
generating a text-based character string from the received text;
associating said text-based character string with one classification;
transmitting said text-based character string to at least one online social networking account configured to receive content from said user.

24. The computer system of claim 23, further comprising receiving a primary URL pointing to content stored on a network server from said user;

25. The computer system of claim 24, further comprising generating an alias URL from said primary URL wherein the content pointed to by primary URL may also be accessed through alias URL;

26. The computer system of claim 25, wherein said text-based character string comprises said alias URL;

27. The computer system of claim 25, wherein said alias URL comprises a text-based character string identifying a protocol, a text-based character string identifying a domain, and a text-based character string identifying a file path and corresponding to said primary URL.

28. The computer system of claim 27, wherein said text-based character string identifying the file path is generated from said primary URL by at least one algorithm.

29. The computer system of claim 25, wherein said alias URL points to a webpage.

30. The computer system of claim 29, wherein said webpage incorporates said content pointed to by said primary URL.

31. The computer system of claim 25, wherein said text-based character string further comprises additional text accompanying said alias URL.

32. The computer system of claim 26, further comprising associating said text-based character string with a landing page.

33. The computer system of claim 32, wherein associating said text-based character string with a landing page is performed by associating said text-based character string's associated classification with a landing page.

34. The computer system of claim 32, wherein said landing page comprises at least one of a link to a binary graphic and a text-based character string of at least one character.

35. The computer system of claim 32, wherein said landing page is received from said user and stored within said system.

36. The computer system of claim 32, wherein said alias URL points to content comprising the content pointed to by said primary URL and said associated landing page.

37. The computer system of claim 23, wherein said classification comprises a text-based character string.

38. The computer system of claim 37, wherein said classification is received from said user and stored within said system.

39. The computer system of claim 23, further comprising associating said classification with at least one keyword.

40. The computer system of claim 39, wherein said at least one keyword comprises a text-based character string.

41. The computer system of claim 41, wherein said at least one keyword is received from said user and stored within said system.

42. The computer system of claim 23, further comprising associating said text-based character string with said unique identifier.

43. The computer system of claim 23, wherein said unique identifier is associated with an organization.

44. The computer system of claim 43, wherein said organization is associated with an agency.
